(19) United States
(12) Patent Application Publication
(10) Pub. No.: US 2017/0087745 A1
(43) Pub. Date: Mar. 30, 2017

(54) Fiber-reinforced Thermoplastic Composite Structure and Method for Making the Same

(71) Applicant: The Boeing Company, Chicago, IL (US)

(72) Inventor: Matthew H. Cawthorne, Wayne, PA (US)

(21) Appl. No.: 14/870,811

(22) Filed: Sep. 30, 2015

(51) Int. Cl. B29C 33/52; B29C 70/34; B29C 70/16; B29C 70/38; B32B 1/08; B29C 33/38

(52) U.S. Cl. CPC B29C 33/52; B32B 1/08; B29C 33/3835; B29C 33/3842; B29C 70/16; B29C 70/382; B29C 70/347; B32B 2305/08; B29K 2995/0062; B29K 2105/256

(57) ABSTRACT

A method for making a thermoplastic composite structure includes the steps of: (1) placing, in situ, fiber-reinforced thermoplastic material around a mandrel, wherein the mandrel includes a soluble material, (2) consolidating, in situ, the fiber-reinforced thermoplastic material to form a thermoplastic composite structure, and (3) at least partially solubilizing the mandrel from within the thermoplastic composite structure to remove the mandrel and provide the thermoplastic composite structure including a material thickness of the fiber-reinforced thermoplastic material, a structure shape, and a hollow interior.

### FIELD

The present disclosure is generally related to composite structures and, more particularly, to fiber-reinforced thermoplastic composite structures and methods for making the same using in situ placement and consolidation of fiber-reinforced thermoplastic material around a soluble mandrel.

### BACKGROUND

Fiber-reinforced composite structures are used in a wide variety of applications due to their high strength-to-weight ratios, corrosion resistance, and other favorable properties. However, the use of fiber-reinforced composite materials in certain applications may be difficult due to the need for large and expensive tools and/or molds, dimensional tolerances and/or requirements, and complex manufacturing methods.

Accordingly, those skilled in the art continue with research and development efforts in the field of fiber-reinforced composite structure manufacturing.

### SUMMARY

In one embodiment, the disclosed thermoplastic composite structure may include a structure shape including an inner mold line and an outer mold line formed by in situ placement and consolidation of fiber-reinforced thermoplastic material around a mandrel, a material thickness of the fiber-reinforced thermoplastic material formed between the inner mold line and the outer mold line of the thermoplastic composite structure, and a hollow interior bound by the inner mold line, wherein the mandrel is removed from within the hollow interior of the thermoplastic composite structure following in situ placement and consolidation of the fiber-reinforced thermoplastic material.

In another embodiment, the disclosed method for making a thermoplastic composite structure may include the steps of: (1) placing, in situ, fiber-reinforced thermoplastic material around a mandrel, wherein the mandrel includes a soluble material, (2) consolidating, in situ, the fiber-reinforced thermoplastic material to form a thermoplastic composite structure, and (3) at least partially solubilizing the mandrel from within the thermoplastic composite structure to remove the mandrel and provide the thermoplastic composite structure including a material thickness of the fiber-reinforced thermoplastic material, a structure shape, and a hollow interior.

In yet another embodiment, the disclosed method for making the thermoplastic composite structure may include the steps of: (1) heating initial ones of tows of fiber-reinforced thermoplastic material, wherein the tows include bundles of reinforcing fibers impregnated with a thermoplastic resin, (2) placing, in situ, the initial ones of the tows onto a mandrel to form an initial one of layers of the fiber-reinforced thermoplastic material around the mandrel, wherein the mandrel includes a soluble material, (3) heating subsequent ones of the tows, (4) placing, in situ, the subsequent ones of the tows onto the initial ones of the tows and preceding ones of the tows to successively form subsequent ones of layers of the fiber-reinforced thermoplastic material around the mandrel, (4) applying a consolidation force to the subsequent ones of the tows to diffuse the thermoplastic resin between the initial ones of the tows and the subsequent ones of the tows and consolidate the initial one of the layers and the subsequent ones of the layers, (5) cooling the initial ones of the tows and the subsequent ones of the tows to cohesively bond the initial one of the layers and the subsequent ones of the layers and form a thermoplastic composite structure, wherein the thermoplastic composite structure includes a material thickness of the fiber-reinforced thermoplastic material, a structure shape, and a hollow interior, and (6) solubilizing the mandrel to remove the mandrel from within the thermoplastic composite structure.

Other embodiments of the disclosed systems and method will become apparent from the following detailed description, the accompanying drawings and the appended claims.

### BRIEF DESCRIPTION OF THE DRAWINGS

FIG. 1 is a schematic block diagram of one example of a manufacturing environment;

FIG. 2 is a schematic perspective view of one example of the disclosed thermoplastic composite structure of FIG. 1;

FIG. 3 is a schematic partial, sectional view of one example of layers of tows of the thermoplastic composite structure;

FIG. 4 is a schematic perspective view of one example of an automated fiber placement machine of FIG. 1 placing tows to form a layer of fiber-reinforced thermoplastic material;

FIG. 5 is a schematic perspective view of one example of the automated fiber placement machine of FIG. 1 placing tows to form a layer of fiber-reinforced thermoplastic material;

FIG. 6 is a schematic perspective view of one example of the automated fiber placement machine of FIG. 1 placing tows to form a layer of fiber-reinforced thermoplastic material;

FIG. 7 is a schematic diagram of the automated fiber placement machine placing tows to form successive layers of fiber-reinforced thermoplastic material around a mandrel;

FIG. 8 is a schematic side elevation view, in section, of one example of the thermoplastic composite structure of FIG. 1;

FIG. 9 is an enlarged schematic side elevation view, in section, of one location on the thermoplastic composite structure of FIG. 8;

FIG. 10 is an enlarged schematic side elevation view, in section, of one location on the thermoplastic composite structure of FIG. 8;

FIG. 11 is a schematic perspective view of one example of the disclosed mandrel of FIG. 1;

FIG. 12 is a schematic perspective view of the mandrel of FIG. 11 coupled to one example of the disclosed tooling fixture of FIG. 1;

FIG. 13 is a schematic perspective view of one example of the disclosed mandrel of FIG. 1;

FIG. 14 is a schematic perspective view of one example of the disclosed mandrel of FIG. 1;

FIG. 15 is a schematic exploded perspective view of one example of a section of the mandrel of FIG. 14;

FIG. 16 is a schematic flow diagram of one example of the disclosed method for making the thermoplastic composite structure of FIG. 1;

FIG. 17 is a schematic flow diagram of one example of the disclosed method for making the thermoplastic composite structure of FIG. 1;

FIG. 18 is a block diagram of aircraft production and service methodology; and

FIG. 19 is a schematic illustration of an aircraft.

### DETAILED DESCRIPTION

The following detailed description refers to the accompanying drawings, which illustrate specific embodiments of the disclosure. Other embodiments having different structures and operations do not depart from the scope of the present disclosure. Like reference numerals may refer to the same element or component in the different drawings.

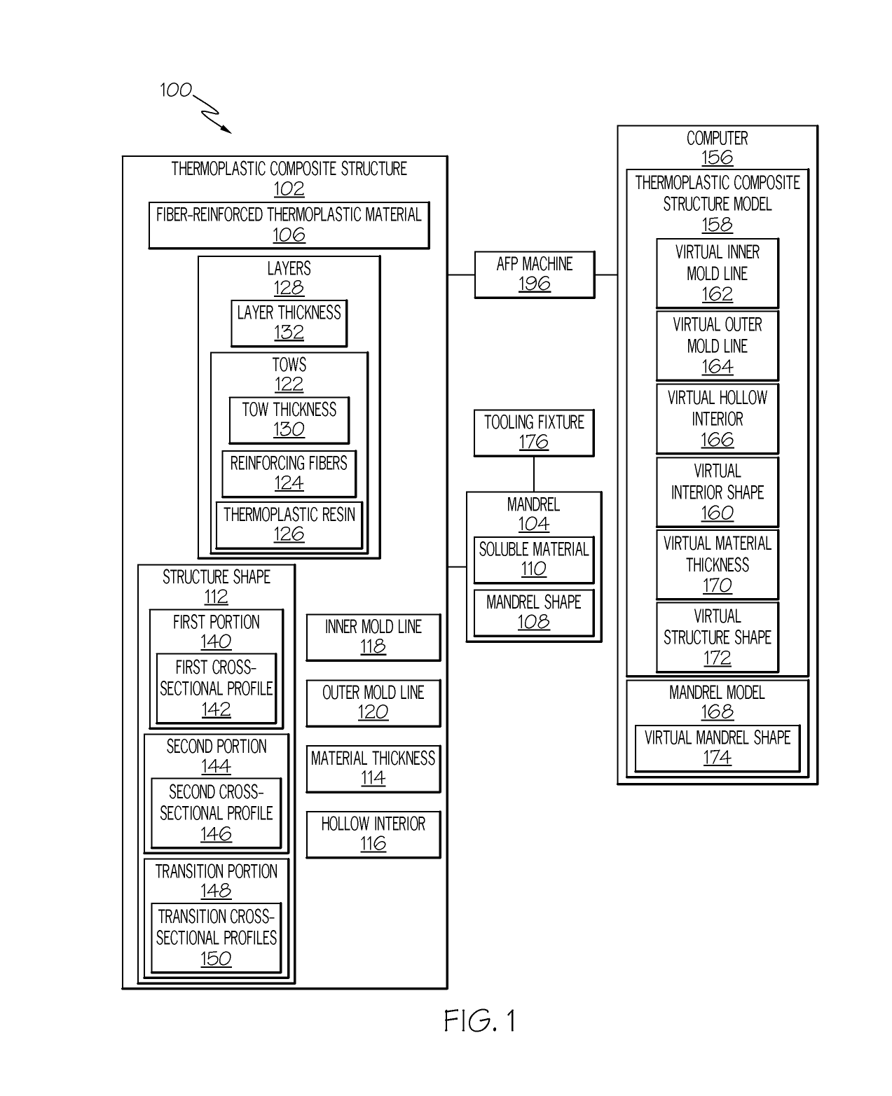

In FIGS. 1 and 19, referred to above, solid lines, if any, connecting various elements and/or components may represent mechanical, electrical, fluid, optical, electromagnetic and other couplings and/or combinations thereof. As used herein, “coupled” means associated directly as well as indirectly. For example, a member A may be directly associated with a member B, or may be indirectly associated therewith, e.g., via another member C. It will be understood that not all relationships among the various disclosed elements are necessarily represented. Accordingly, couplings other than those depicted in the block diagrams may also exist. Dashed lines, if any, connecting blocks designating the various elements and/or components represent couplings similar in function and purpose to those represented by solid lines; however, couplings represented by the dashed lines may either be selectively provided or may relate to alternative examples of the present disclosure. Likewise, elements and/or components, if any, represented with dashed lines, indicate alternative examples of the present disclosure. One or more elements shown in solid and/or dashed lines may be omitted from a particular example without departing from the scope of the present disclosure. Environmental elements, if any, are represented with dotted lines. Virtual (imaginary) elements may also be shown for clarity. Those skilled in the art will appreciate that some of the features illustrated in FIGS. 1 and 19 may be combined in various ways without the need to include other features described in FIGS. 1 and 19, other drawing figures, and/or the accompanying disclosure, even though such combination or combinations are not explicitly illustrated herein. Similarly, additional features not limited to the examples presented, may be combined with some or all of the features shown and described herein.

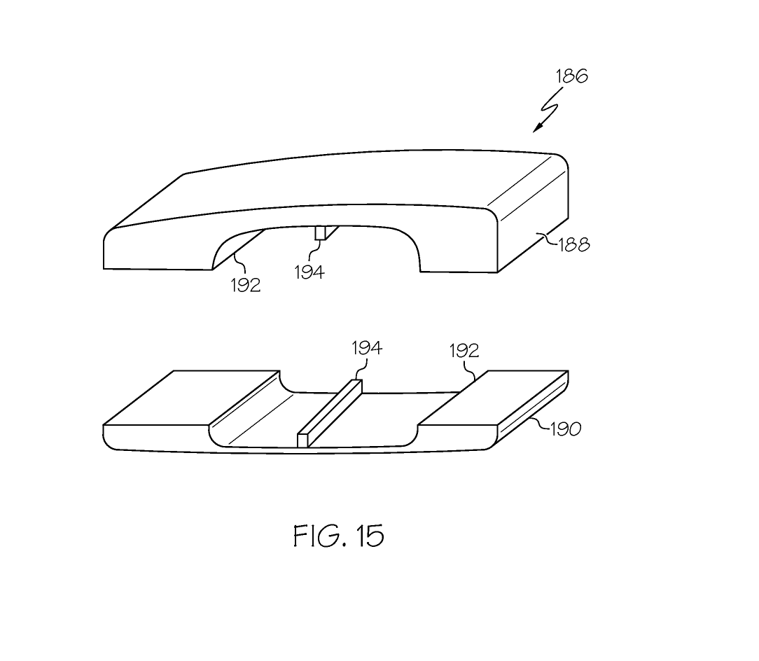

In FIGS. 15-18, referred to above, the blocks may represent operations and/or portions thereof and lines connecting the various blocks do not imply any particular order or dependency of the operations or portions thereof. Blocks represented by dashed lines indicate alternative operations and/or portions thereof. Dashed lines, if any, connecting the various blocks represent alternative dependencies of the operations or portions thereof. It will be understood that not all dependencies among the various disclosed operations are necessarily represented. FIGS. 15-18 and the accompanying disclosure describing the operations of the method(s) set forth herein should not be interpreted as necessarily determining a sequence in which the operations are to be performed. Rather, although one illustrative order is indicated, it is to be understood that the sequence of the operations may be modified when appropriate. Accordingly, certain operations may be performed in a different order or simultaneously. Additionally, those skilled in the art will appreciate that not all operations described need be performed.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

Reference herein to “example” means that one or more feature, structure, or characteristic described in connection with the example is included in at least one embodiment or implementation. The phrase “one example,” “another example,” and the like in various places in the specification may or may not be referring to the same example.

Illustrative, non-exhaustive examples, which may or may not be claimed, of the subject matter according the present disclosure are provided below.

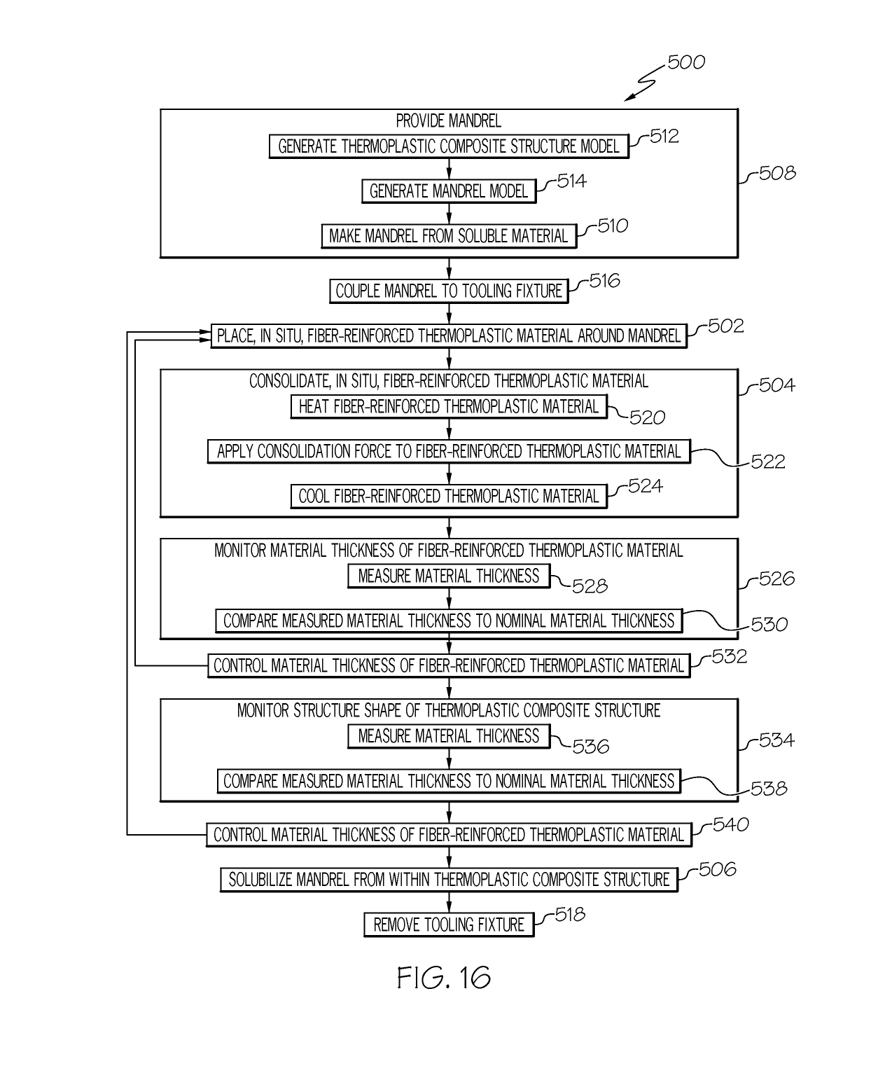

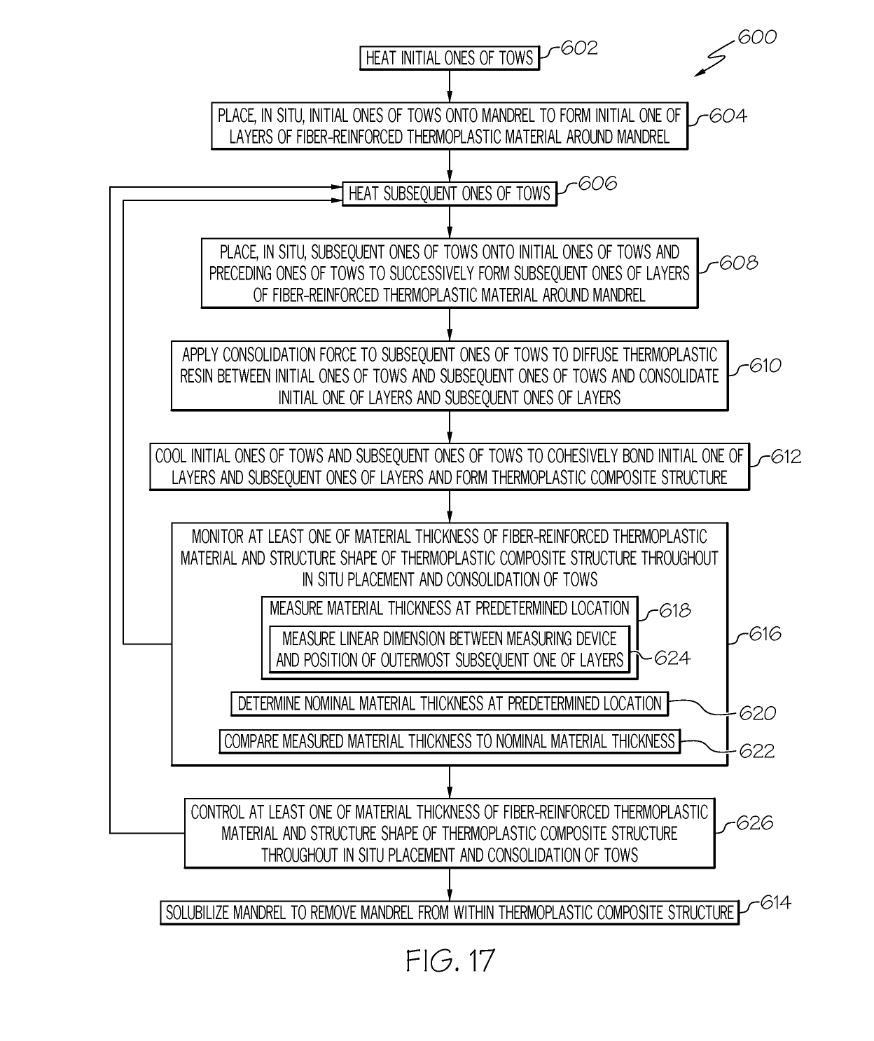

Referring to FIG. 1, one example of manufacturing environment, generally designated 100, for making thermoplastic composite structure 102, is disclosed. Manufacturing environment 100 may be any suitable workspace or facility where one or more manufacturing operations are performed to make or fabricate thermoplastic composite structure 102 and/or mandrel 104. As one example, manufacturing environment 100 may be used during one or more implementations of method 500 (FIG. 16) and/or method 600 (FIG. 17).

Thermoplastic composite structure 102 may be incorporated into a larger manufactured article, such as a vehicle. As one general, non-limiting example, thermoplastic composite structure 102 may be employed as a component or part of an aircraft or other air vehicle (e.g., aircraft 1200) (FIG. 19). As examples, the disclosed thermoplastic composite structure 102 may be employed as a component or part of commercial (e.g., passenger) aircraft, cargo aircraft, military aircraft, rotorcraft, unmanned aerial vehicles, and other types of aircraft or aerial vehicles, as well as aerospace vehicles, satellites, space launch vehicles, rockets, and other aerospace vehicles.

As one specific, non-limiting example, thermoplastic composite structure 102 is a rotor blade, for example, of a rotary-wing aircraft. As one specific, non-limiting example, thermoplastic composite structure 102 is a propeller, for example, of a fixed-wing aircraft. As other specific, non-limiting examples, thermoplastic composite structure 102 may be a wing, a stabilizer (e.g., a horizontal or vertical stabilizer), another structure of an aircraft, a mast, a robotic arm, a fuel tank, a pressure cylinder, prosthetic device, or another structure.

Although the disclosed thermoplastic composite structure 102 is generally disclosed herein as being utilized with aircraft, it may also be appreciated that examples of structures and methods in accordance with this disclosure may be utilized in other transport vehicles, such as boats and other watercraft, trains, automobiles, trucks, buses, or other suitable transport vehicles formed from or utilizing thermoplastic composite structures.

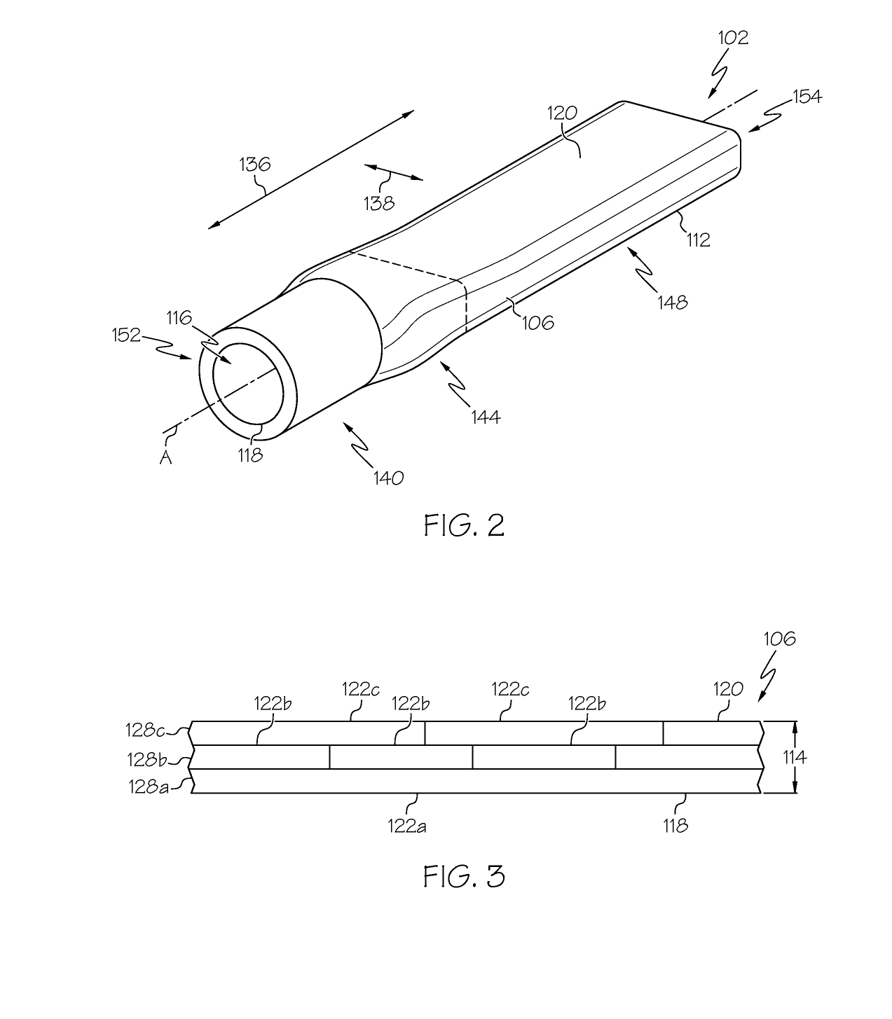

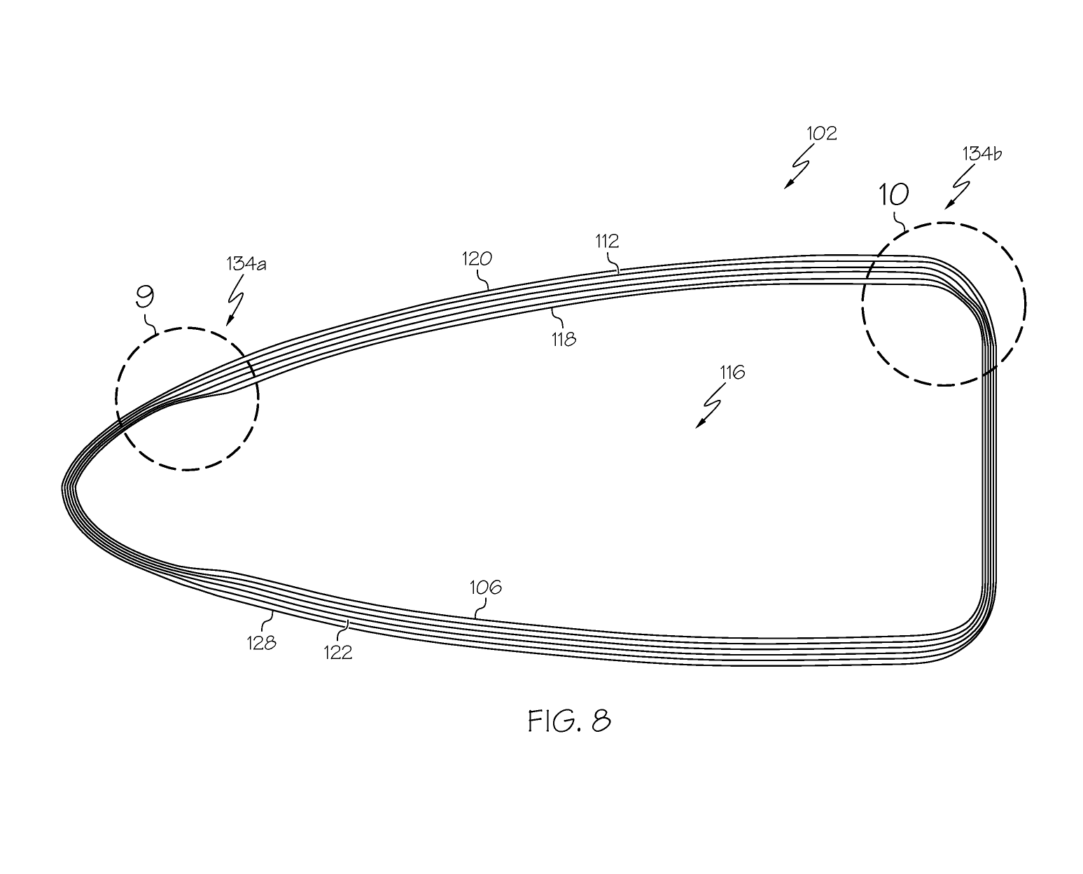

Referring to FIG. 1, and with reference to FIGS. 2 and 8, in one example, thermoplastic composite structure 102 includes structure shape 112 including inner mold line 118, also referred to as an inner finished shape (e.g., of an interior surface), and outer mold line 120, also referred to as an outer finished shape (e.g., of an exterior surface), formed by in situ placement and consolidation of fiber-reinforced thermoplastic material 106 around mandrel 104. Thermoplastic composite structure 102 also includes material thickness 114 of fiber-reinforced thermoplastic material 106 formed between inner mold line 118 and outer mold line 120 of thermoplastic composite structure 102. Thermoplastic composite structure 102 also includes hollow interior 116 bound by inner mold line 118. Mandrel 104 is removed from thermoplastic composite structure 102 following in situ placement and consolidation of fiber-reinforced thermoplastic material 106. Hollow interior 116 is formed upon removal of mandrel 104.

In situ placement and consolidation of fiber-reinforced thermoplastic material 106 around mandrel 104 enables direct control over one or both of material thickness 114 of fiber-reinforced thermoplastic material 106 of thermoplastic composite structure 102 and/or structure shape 112 of thermoplastic composite structure 102. Thus, a predetermined material thickness 114 and/or a predetermined structure shape 112 may be achieved without a molding process, for example, without use of an exterior (e.g., compression) mold or tooling assembly; a pressurizing process, for example, via a vacuum bag; or a curing process, for example, via an oven or autoclave.

Referring to FIG. 1, and with reference to FIG. 3, in one example, fiber-reinforced thermoplastic material 106 includes reinforcing fibers 124 impregnated (e.g., pre-impregnated) with thermoplastic resin 126. As one example, fiber-reinforced thermoplastic material 106 are fiber-reinforced thermoplastic tows 122 (e.g., tows of fiber-reinforced thermoplastic material 106). Tows 122 may include bundles of reinforcing fibers 124 held together by thermoplastic resin 126. As examples, tows 122 may take the form of fiber tape, woven fabric, non-woven fabric, a commingled fiber material, or another suitable fiber-reinforced thermoplastic material.

Each one of tows 122 includes tow thickness 130. Tow thickness 130 may range from approximately 104 micrometers (0.0041 inch) to approximately 208 micrometers (0.0082 inch). Any other feasible tow thicknesses 130 are also contemplated. As one example, tow thicknesses 130 of all of tows 122 are different. As one example, tow thickness 130 of at least one of tows 122 is different from tow thickness 130 of at least another one of tows 122.

Reinforcing fibers 124 may be continuous fibers, woven fibers, braided fibers, discontinuous fibers, fiber mat, any combination thereof, or any other suitable form. Reinforcing fibers 124 may be any other fiber material that has high strength, stiffness, energy absorption, or any other desirable property. As example, reinforcing fibers 124 may be carbon fibers, carbon nanotubes, glass fibers, ceramic fibers, aramid fibers, metal fibers (e.g., used on aircraft structures to shield underlying composite material from lightning), boron fibers, polymer fibers, organic fibers (e.g., silk fibers) and any combination thereof. Reinforcing fibers 124 may have any suitable diameter, for example, ranging from approximately 1 nanometer to approximately 142 micrometers. Any other feasible dimensions of reinforcing fibers 124 are also contemplated without limitation.

Thermoplastic resin 126 may be any suitable thermoplastic polymer matrix material. As examples, thermoplastic resin 126 may be polyether ether ketone (“PEEK”), polyetherketoneketone (“PEKK”), polypheylene sulfide (“PPS”), polyethyleneimine (“PEI”), polyetherketone (“PEK”), polyarlyetherketone (“PAEK”), polyphenylene sulfide (“PPS”), polyimide (“PI”), thermoplastic polyimide (“TPI”), polyetherimide (“PEI”), polypropylene (“PP”), polyethylene (“PE”), polybutylene terephthalate (“PBT”), fluorinated ethylene propylene (“FEP”), perfluoroalkoxy (“PFA”), polyvinylidene fluoride (“PVDF”), polytetrafluoroethylene (“TFE”), ethylene tetrafluoroethylene (“ETFE”), (polyethylene terephthalate (“PET”), thermoplastic polyurethane (“TPU”), (polyamide (“PA”), polyamide-imide (“PAI”), PBT polybutylene terephthalate (“PBT”), nylon, or any combination thereof.

As one specific, non-limiting example, fiber-reinforced thermoplastic material 106 includes tows 122 of continuous unidirectional carbon fiber-reinforced PEEK.

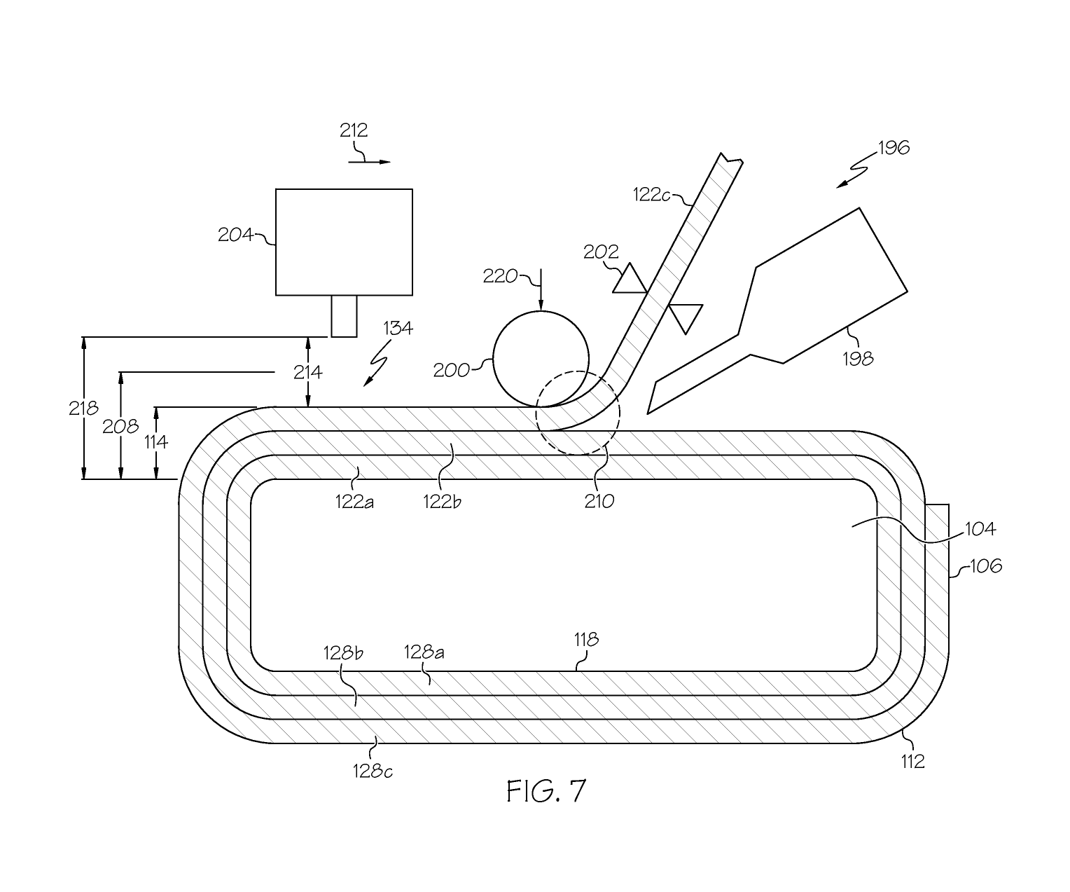

Referring to FIG. 1, and with reference to FIGS. 3-10, in one example, thermoplastic composite structure 102 includes layers 128 of fiber-reinforced thermoplastic material 106 formed from successive in situ placement of tows 122. As one non-limiting example, three individual layers 128a, 128b, and 128c are illustrated in FIG. 3. As one non-limiting example, tows 122a form layer 128a, tows 122b form layer 128b, and tows 122c form layer 128c in FIG. 3. While not explicitly illustrated in FIG. 3, additional layers 128 (e.g., more than three layers) formed from in situ placement and consolidation of additional tows 122 are also contemplated in order to provide a desired material thickness and/or structure shape, for example, as illustrated in FIGS. 7-9.

As one example, ones of tows 122 (e.g., tows 122a) forming an innermost one of layers 128 (e.g., layer 128a) define inner mold line 118. Other ones of tows 122 (e.g., 122c) forming an outermost one of layers 128 (e.g., layer 128c) define outer mold line 120. Tow thicknesses 130 (FIG. 1) of tows 122 forming each one of layers 128 define layer thickness 132 (FIG. 1) of each one of layers 128. A combination of layer thicknesses 132 (e.g., a combination of tow thicknesses 130) defines material thickness 114 (FIG. 3).

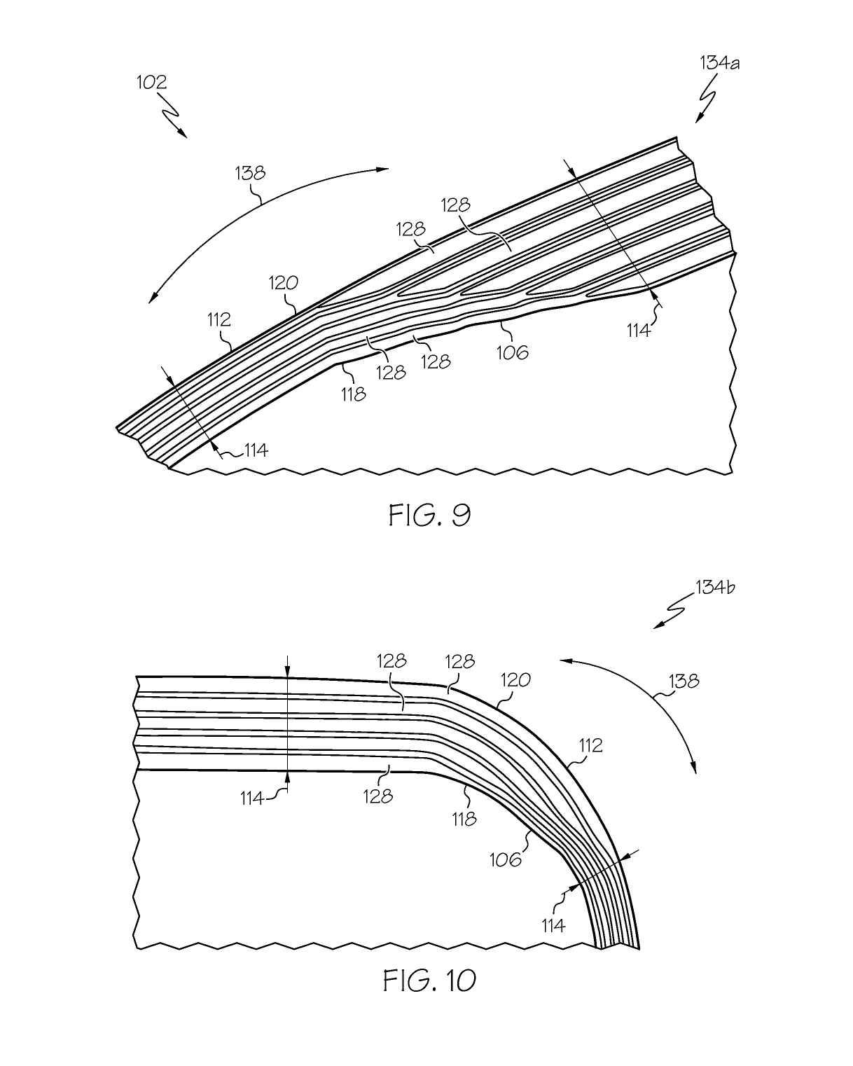

Referring to FIGS. 9 and 10, and with reference to FIG. 8, as one example, material thickness 114 at locations 134 (designated generally as location 134a in FIGS. 8 and 9 and location 134b in FIGS. 8 and 10) on thermoplastic composite structure 102 may be controlled by at least one of a number of tows 122 (e.g., the number of layers 128) at locations 134a, 134b and/or tow thickness 130 of each one of tows 122 (e.g., layer thickness 132 of each one of layers 128) at locations 134a, 134b.

As one example, structure shape 112 at locations 134a, 134b on thermoplastic composite structure 102 may be controlled by an in situ placement position of at least one of tows 122 (e.g., forming one of layers 128) relative to another in situ placement position of at least another one of tows 122 (e.g., forming the one of layers 128 or another one of layers 128). As one example, structure shape 112 at locations 134a, 134b on thermoplastic composite structure 102 may also be controlled by at least one of a number of tows 122 (e.g., the number of layers 128) at locations 134a, 134b and/or tow thickness 130 of each one of tows 122 (e.g., layer thickness 132 of each one of layers 128) at locations 134a, 134b.

For clarity of illustration in FIGS. 8 and 9, individual tows 122 are not explicitly illustrated and not every one of layers 128 is explicitly identified.

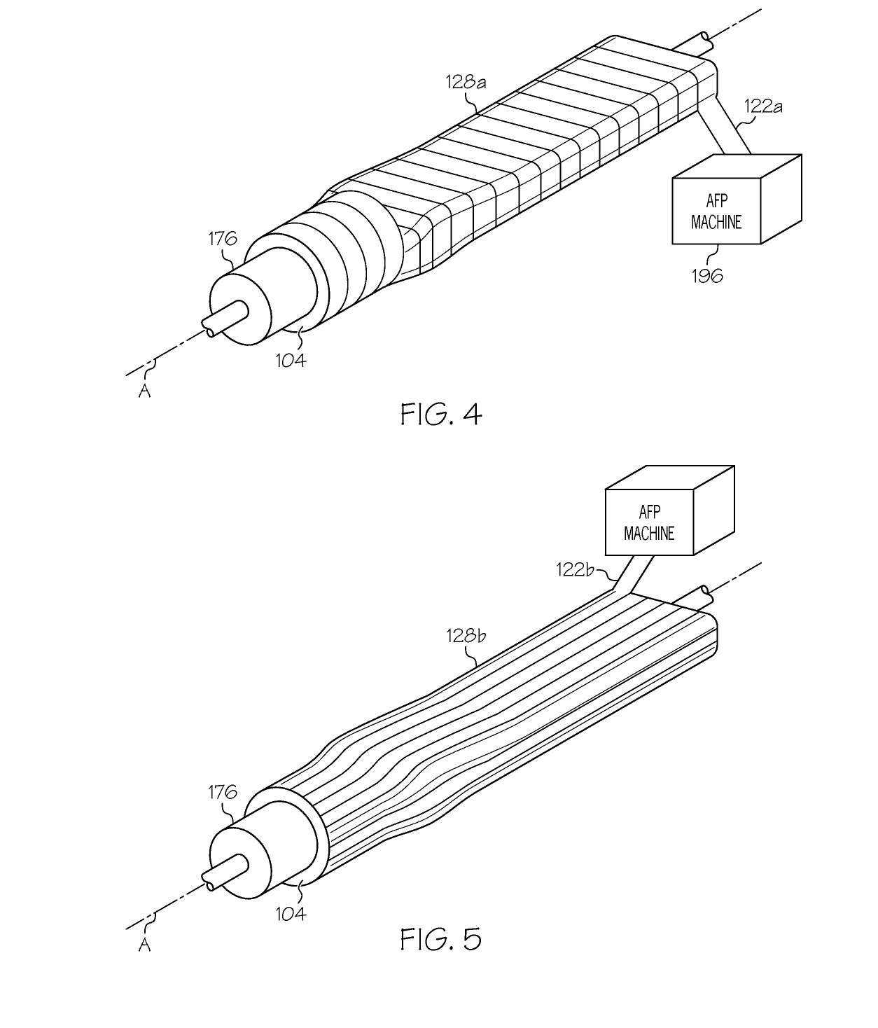

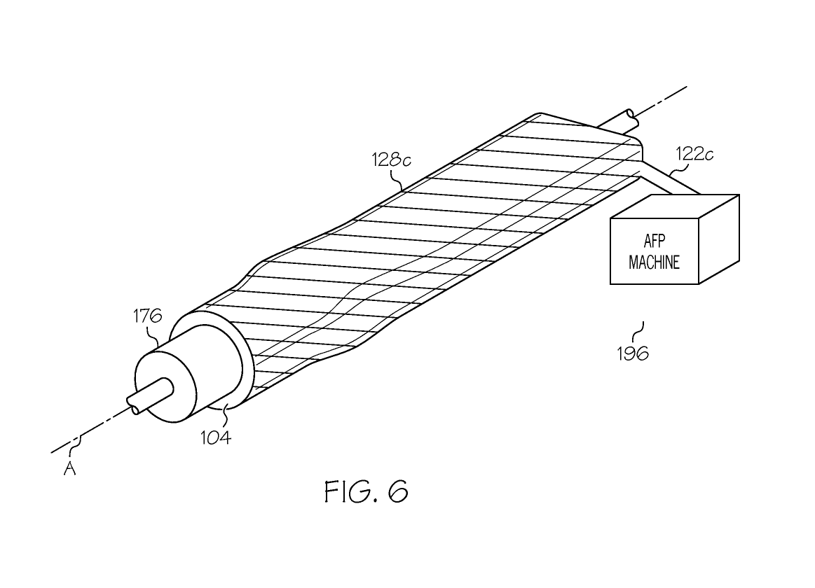

Referring to FIGS. 4-6, and with reference to FIGS. 1 and 3, in one example, at least one of layers 128 (e.g., layer 128a) is formed by ones tows 122 (e.g., tows 122a) placed, in situ, at a first angle relative to longitudinal axis A of thermoplastic composite structure 102, as illustrated in FIG. 4. As one example, the first angle may be approximately a ninety-degree angle relative to longitudinal axis A of thermoplastic composite structure 102. At least another one of layers 128 (e.g., layer 128b) is formed by ones of tows 122 (e.g., tows 122b) placed, in situ, at second angle relative to longitudinal axis A of thermoplastic composite structure 102 that is different from the first angle, as illustrated in FIG. 5. As one example, the second angle may be approximately a zero-degree angle relative to longitudinal axis A of thermoplastic composite structure 102. At least yet another one of layers 128 (e.g., 128c) is formed by yet other ones of tows 122 (e.g., tows 122c) placed at a third angle (e.g., approximately a forty-five-degree angle) relative to longitudinal axis A of thermoplastic composite structure 102 that is different from both the first angle and the second angle, as illustrated in FIG. 6. As one example, the third angle may be approximately a forty-five-degree angle relative to longitudinal axis A of thermoplastic composite structure 102.

While example orientation angles (e.g., the first angle, the second angle and the third angle) of tows 122 (e.g., tows 122a, 122b and 122c) forming each one of layers 128 (e.g., layers 128a, 128b and 128c) are illustrated in FIGS. 4-6, different orientation angles relative to longitudinal axis A of thermoplastic composite structure 102 (e.g., any angle ranging between approximately a zero-degree angle and approximately a ninety-degree angle) are also contemplated. Further, additional ones of tows 122 forming additional ones of layers 128 at additional orientation angles (e.g., a fourth angle, a fifth angle, etc.) are also contemplated without limitation.

Referring to FIG. 2, and with reference to FIGS. 1 and 8, in one example, structure shape 112 varies along lengthwise (or spanwise) direction 136 of thermoplastic composite structure 102 (e.g., from first end 152 of thermoplastic composite structure 102 to a longitudinally opposed second end 154 of thermoplastic composite structure 102). As illustrated in FIG. 8, structure shape 112 is a geometric cross-sectional shape of thermoplastic composite structure 102 defined by outer mold line 120 (e.g., an outermost layer 128 of tows 122).

Referring to FIG. 2, and with reference to FIG. 1, in one example, structure shape 112 of thermoplastic composite structure 102 includes first portion 140 including first cross-sectional profile 142 (FIG. 1). Structure shape 112 also includes second portion 144 including second cross-sectional profile 146 (FIG. 1). First cross-sectional profile 142 and second cross-sectional profile 146 are different. Structure shape 112 also includes transition portion 148 extending between first portion 140 and second portion 144. Transition portion 148 includes transition cross-sectional profiles 150 (FIG. 1) that are different from and transition between first cross-sectional profile 142 and second cross-sectional profile 146.

As one example, first cross-sectional profile 142 has a circular shape. As one example, first cross-sectional profile 142 has an ovular shape. As one example, second cross-sectional profile 146 has a rectangular shape. As one example, second cross-sectional profile 146 has an ovular shape. As one example, second cross-sectional profile 146 has an airfoil shape. Transition cross-sectional profiles 150 gradually transition between first cross-sectional profile 142 and second cross-sectional profile 146. Other geometric shapes for first cross-sectional profile 142, second cross-sectional profile 146, and transition cross-sectional profiles 150 are also contemplated.

As one example, at least one of first cross-sectional profile 142 and/or second cross-sectional profile 146 is symmetric. As one example, at least one of first cross-sectional profile 142 and/or second cross-sectional profile 146 is asymmetric.

In another example, structure shape 112 of thermoplastic composite structure 102 has a constant cross-sectional profile (not explicitly illustrated) along lengthwise direction 136.

Referring to FIGS. 9 and 10, and with reference to FIGS. 1 and 8, as one example, material thickness 114 of fiber-reinforced thermoplastic material 106 of thermoplastic composite structure 102 varies along lengthwise direction 136 (FIG. 2) of thermoplastic composite structure 102.

As one example, material thickness 114 of fiber-reinforced thermoplastic material 106 of thermoplastic composite structure 102 varies along streamwise direction 138 (FIG. 2) of thermoplastic composite structure 102. In certain example implementations, streamwise direction 138 may continue around a circumference of mandrel 104 to form a hoop (e.g., forming a hoopwise direction).

Referring to FIG. 16, one example of method, generally designated 500, for making a thermoplastic composite structure (e.g., thermoplastic composite structure 102) (FIG. 1), is disclosed. Modifications, additions, or omissions may be made to method 500 without departing from the scope of the present disclosure. Method 500 may include more, fewer, or other steps. Additionally, steps may be performed in any suitable order.

Referring to FIG. 16, and with reference to FIG. 1, in one example implementation, method 500 includes the step of placing, in situ, fiber-reinforced thermoplastic material around mandrel 104, as shown at block 502. Method 500 also includes the step of consolidating, in situ, fiber-reinforced thermoplastic material 106 to form thermoplastic composite structure 102, as shown at block 504. Method 500 also includes the step of at least partially solubilizing mandrel 104 from within thermoplastic composite structure 102, as shown at block 506. Solubilizing mandrel 104 (block 504) removes mandrel 104 from within thermoplastic composite structure 102 and provides thermoplastic composite structure 102 having material thickness 114 of fiber-reinforced thermoplastic material 106, structure shape 112, and hollow interior 116.

Referring to FIG. 16, and with reference to FIG. 1, in one example implementation, method 500 also includes the step of providing mandrel 104, as shown at block 508. As one example, providing mandrel 104 (block 508) includes making mandrel 104 from soluble material 110, as shown at block 510.

Making mandrel 104 (block 510) may include any suitable manufacturing or fabricating process. As one example, making mandrel 104 is performed using an additive manufacturing process. As one example, making mandrel 104 is performed using a molding process. As one example, making mandrel 104 is performed using a casting process. As one example, making mandrel 104 is performed using a machining process.

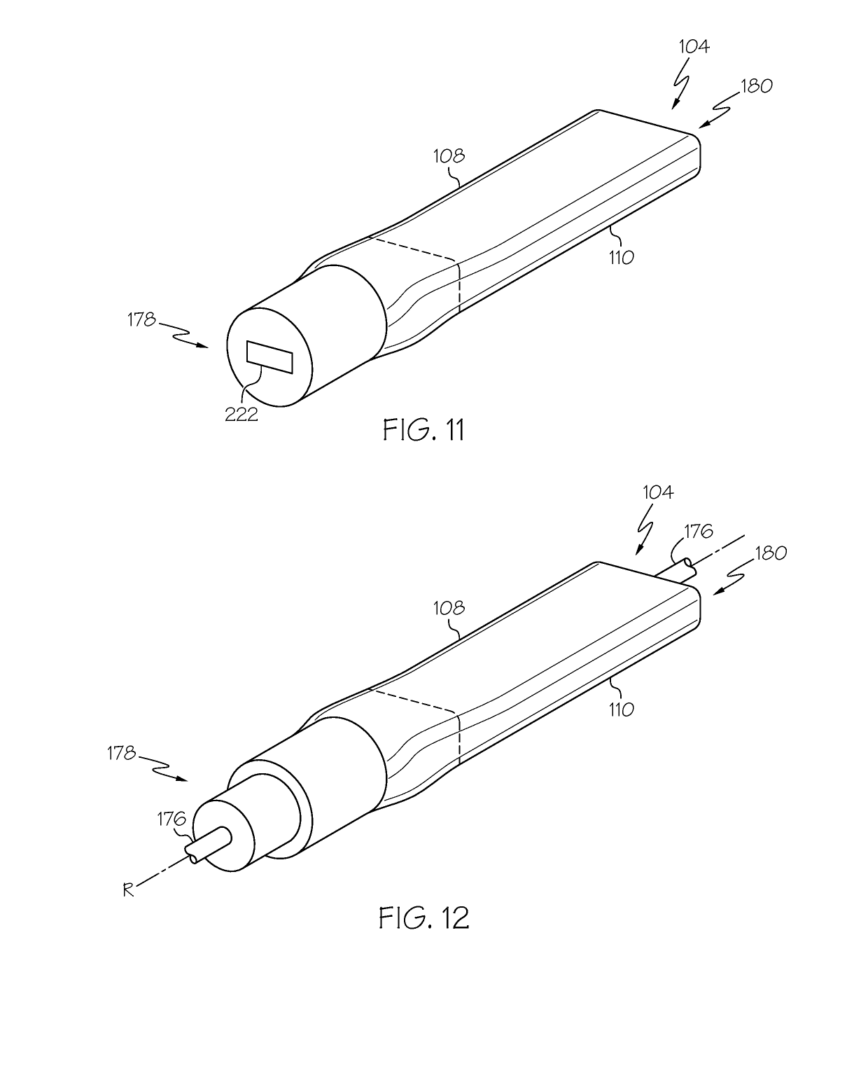

Referring to FIG. 1, and with reference to FIG. 11, in one example, mandrel 104 is made from soluble material 110. Soluble material 110 may be any material that is at least partially or completely soluble when exposed to a solubilizing agent. As non-limiting examples, soluble material 110 may include a soluble ceramic material, a soluble polymer material, other soluble materials or a combination thereof. As examples, soluble material 110 may include one or more soluble materials including ceramic, sand, a polymer binder, a soluble organic binder, a soluble inorganic binder, sodium silicate, graphite, one or more additives, and one or more preservatives, or another suitable soluble material. The solubilizing agent may include any material capable of at least partially or completely solubilizing soluble material 110 of mandrel 104. As one example, the solubilizing agent may be in the form of a liquid (e.g., water or another water-based solution) to wash out and to permanently remove mandrel 104 from within thermoplastic composite structure 102.

As one example, solubilizing mandrel 104 (block 506) (FIG. 15) may be performed by a mandrel removal apparatus (not explicitly illustrated). As one example, the mandrel removal apparatus may include a washing vessel that dispenses the solubilizing agent (e.g., water). As examples, the combination of thermoplastic composite structure 102 and mandrel 104 may be washed, rinsed, sprayed, dipped, etc. with the solubilizing agent in order to at least partially or completely wash out and permanently remove mandrel 104 from within thermoplastic composite structure 102.

In one example, mandrel 104 is made from a meltable material (not explicitly illustrated). The meltable material may be any material that is at least partially or completely meltable when heated to a melting temperature. The melting temperature of the meltable material is lower than a temperature required to deform fiber-reinforced thermoplastic material 106. Thus, in one example implementation, method 500 also includes the step of melting mandrel 104 to remove mandrel 104 from within thermoplastic composite structure 102 (not explicitly illustrated).

In one example, mandrel 104 may be made from a combination of soluble material 110 and the meltable material. Thus, in one example implementation, method 500 also includes the step of solubilizing and melting mandrel 104 to remove mandrel 104 from within thermoplastic composite structure 102 (not explicitly illustrated).

Referring to FIG. 1, and with reference to FIG. 11, in one example, mandrel 104 includes mandrel shape 108. Mandrel shape 108 may include any geometric shape. Mandrel shape 108 corresponds to and forms hollow interior 116 (FIG. 8) of thermoplastic composite structure 102 bound by inner mold line 118 (FIG. 8) of thermoplastic composite structure 102.

Referring to FIG. 16, and with reference to FIG. 1, in one example, providing mandrel 104 (block 508) includes generating, for example, by computer 156, thermoplastic composite structure model 158 (e.g., three-dimensional representation of thermoplastic composite structure 102), as shown at block 512. Thermoplastic composite structure model 158 includes virtual inner mold line 162 corresponding to inner mold line 118 of thermoplastic composite structure 102, virtual outer mold line 164 corresponding to outer mold line 120 of thermoplastic composite structure 102, virtual hollow interior 166 bound by virtual inner mold line 162 corresponding to hollow interior 116 bound by inner mold line 118 of thermoplastic composite structure 102, virtual material thickness 170 corresponding to material thickness 114 of fiber-reinforced thermoplastic material 106 of thermoplastic composite structure 102, and virtual structure shape 172 corresponding to structure shape 112 of thermoplastic composite structure 102. Hollow interior 166 includes virtual interior shape 160.

Referring to FIG. 16, and with reference to FIG. 1, in one example, providing mandrel 104 (block 508) also includes generating, for example, by computer 156, mandrel model 168 (e.g., a three-dimensional representation of mandrel 104), as shown at block 514. Mandrel model 168 includes virtual mandrel shape 174. Virtual mandrel shape 174 is defined by virtual interior shape 160. Mandrel 104 made in accordance with the disclosed method 500 (block 510) includes mandrel shape 108 corresponding to virtual mandrel shape 174.

Computer 156 may include a processor, memory, and instructions, that when executed by the processor, generate thermoplastic composite structure model 158 and mandrel model 168.

Referring to FIG. 16, and with reference to FIG. 1, in one example implementation, method 500 also includes the step of coupling mandrel 104 to tooling fixture 176, as shown at block 516. Method 500 also includes the step of removing tooling fixture 176 following solubilizing mandrel 104 (block 504), as shown at block 518.

Referring to FIG. 12, and with reference to FIGS. 1 and 11, as one example, mandrel 104 is coupled to tooling fixture 176. Tooling fixture 176 may be coupled to first end 178 and a longitudinally opposed second end 180 of mandrel 104. As one example, mandrel 104 is clamped between tooling fixture 176. Tooling fixture 176 may extend through mandrel 104. As one example, and as illustrated in FIG. 10, mandrel 104 includes opening 222 that extends from first end 178 to second end 180. Tooling fixture 176 may extend through opening 222.

As one example, tooling fixture 176 is configured to secure and maintain mandrel 104 is a fixed and stationary position during in situ consolidation of fiber-reinforced thermoplastic material 106 around mandrel 104 to form thermoplastic composite structure 102 (block 502). As one example, tooling fixture 176 is configured to move mandrel 104, for example, linearly (e.g., along an X-axis, Y-axis, and/or a Z-axis) and/or rotationally, for example, about rotational axis R defined by tooling fixture 176 during in situ consolidation of fiber-reinforced thermoplastic material 106 around mandrel 104 to form thermoplastic composite structure 102.

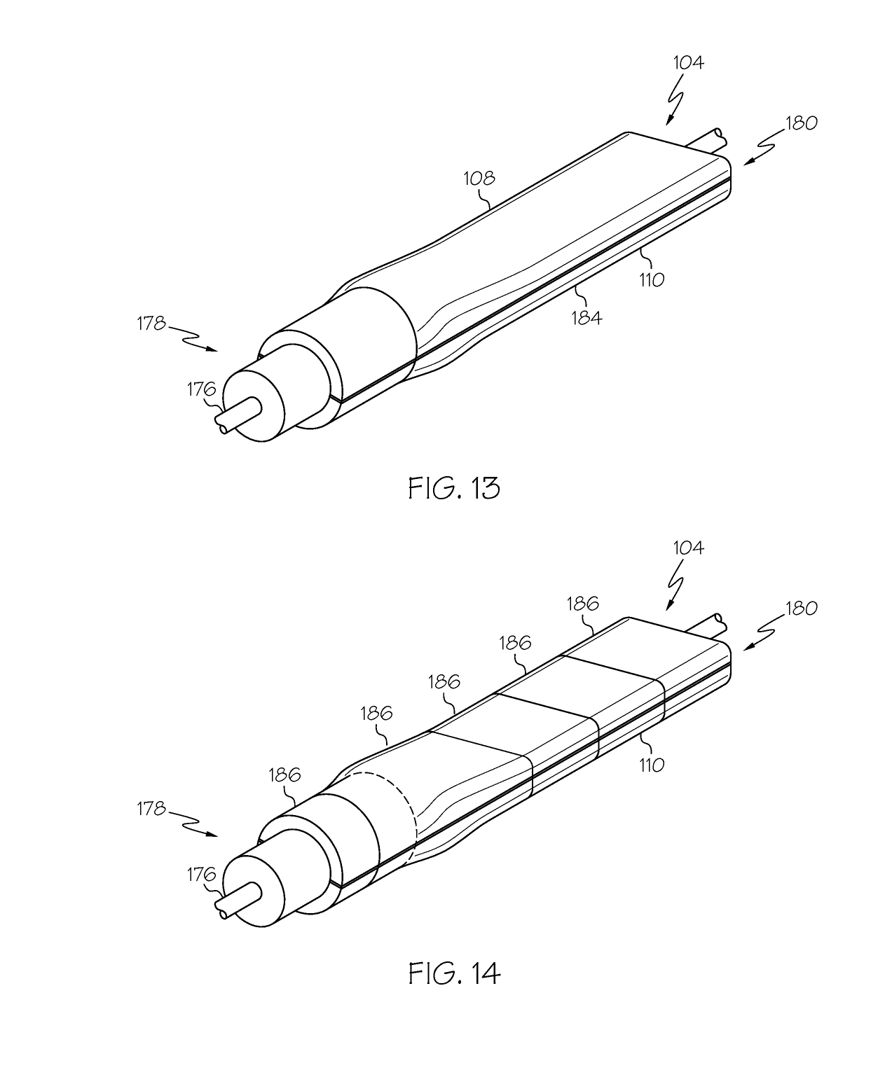

Referring to FIG. 13, and with reference to FIG. 1, in one example, mandrel 104 includes first longitudinal half 182 and second longitudinal half 184. In one example implementation, coupling mandrel 104 to tooling fixture 176 (block 516) includes coupling first longitudinal half 182 and second longitudinal half 184 around tooling fixture 176. Each one of first longitudinal half 182 and second longitudinal half 184 may include a recess (not illustrated in FIG. 12) that, in combination, forms opening 222 (FIG. 10) through mandrel 104.

Referring to FIGS. 14 and 15, and with reference to FIG. 1, in one example, mandrel 104 includes sections 186. Each one of sections 186 includes first section half 188 and second section half 190 (FIG. 14). In one example implementation, coupling mandrel 104 to tooling fixture 176 (block 516) includes coupling first section half 188 and second section half 190 of each one of sections 186 around tooling fixture 176.

Referring to FIG. 15, and with reference to FIGS. 1 and 14, each one of first section half 188 and second section half 190 may include recess 192 that, in combination, forms opening 222 (FIG. 11) through mandrel 104. Each one of first section half 188 and second section half 190 may also include lock feature 194 disposed within recess 192. Lock feature 194 may engage a complementary lock feature (not explicitly illustrated) disposed on tooling fixture 176 to prevent rotational movement of mandrel 104 relative to tooling fixture 176. As one example, and as illustrated in FIG. 15, lock feature 194 may be a tab or tongue extending into opening 222 (FIG. 11) that matingly engages a groove of the complementary lock feature of tooling fixture 176. Alternatively, as one example (not explicitly illustrated), lock feature 194 may be a groove that matingly engages a tab or tongue of the complementary lock feature of tooling fixture 176. Other configurations of lock feature 194 and the complementary lock feature are also contemplated.

Referring to FIG. 16, and with reference to FIGS. 1-11, in one example implementation, consolidating, in situ, fiber reinforced thermoplastic material 106 (block 504) includes heating fiber-reinforced thermoplastic material 106, as shown at block 520. As one example, heating fiber-reinforced thermoplastic material 106 (block 520) is performed immediately before or during in situ placement of fiber-reinforced thermoplastic material 106 (block 502). Consolidating, in situ, fiber reinforced thermoplastic material 106 also includes applying a consolidation force 220 (e.g., a consolidating pressure) (FIG. 7) to fiber-reinforced thermoplastic material 106, as shown at block 522. As one example, applying consolidation force 220 (block 522) is performed during in situ placement of fiber-reinforced thermoplastic material 106 (block 502). Consolidating, in situ, fiber reinforced thermoplastic material 106 also includes cooling fiber-reinforced thermoplastic material 106, as shown at block 524. As one example, cooling fiber-reinforced thermoplastic material 106 (block 524) is performed after in situ placement of fiber-reinforced thermoplastic material 106. Cooling fiber-reinforced thermoplastic material 106 (e.g., tows 122) (block 524) may be performed at ambient temperature. As one example, cooling fiber-reinforced thermoplastic material 106 (e.g., tows 122) is performed between approximately 68 degrees and approximately 79 degrees Fahrenheit (e.g., at generally room temperature).

Generally, consolidating fiber-reinforced thermoplastic material 106 (block 504) melt bonds adjacent layers 128 of fiber-reinforced thermoplastic material 106 together. Heating fiber-reinforced thermoplastic material 106 (block 520) decreases the viscosity of thermoplastic resin 126 (FIG. 1) of fiber-reinforced thermoplastic material 106. Placing fiber-reinforced thermoplastic material 106 (block 502) brings surfaces of two adjacent layers 128 into direct contact. Applying consolidation force 220 to heated fiber-reinforced thermoplastic material 106 (block 522) brings the surfaces of the two adjacent layers 128 into intimate contact such that polymer chains of thermoplastic resin 126 diffuse (e.g., molecular diffusion) between the two adjacent layers 128, for example, via thermal vibrations, and entangle to form a bond. Cooling fiber-reinforced thermoplastic material 106 (block 524) achieves a cohesive thermoplastic fusion bond between the two adjacent layers 128.

In situ, placement and consolidation of fiber-reinforced thermoplastic material 106 to form successive layers 128 of fiber-reinforced thermoplastic material 106 builds up material thickness 114 and forms structure shape 112 essentially through an additive manufacturing process. Accordingly, each layer 128 is consolidated in place and, thus, removing the requirement of applying heat and/or high pressure to (e.g. to cure) the entire stack of layers to form the final structure. Further, material thickness 114 of fiber-reinforced thermoplastic material 106 of thermoplastic composite structure 102 and structure shape 112 of thermoplastic composite structure 102 may be continuously monitored and/or controlled throughout the in situ placement and consolidation process. Additionally, defects, for example, in material thickness 114 and/or structure shape 112 may be identified and corrected immediately as part of the process of making thermoplastic composite structure 102.

Referring to FIG. 16, and with reference to FIG. 1, in one example implementation, method 500 also includes the step of monitoring material thickness 114 of fiber-reinforced thermoplastic material 106 throughout in situ placement of fiber-reinforced thermoplastic material 106 around mandrel 104 (block 502), as shown at block 526.

As one example, monitoring material thickness 114 of fiber-reinforced thermoplastic material 106 (block 526) includes measuring material thickness 114, for example, at predetermined location 134, as shown at block 528, and comparing a measured material thickness 114 to nominal material thickness 208 (FIG. 7), for example, at predetermined location 134 (FIG. 7), as shown at block 530. As one example, nominal material thickness 208 may correspond to (e.g., be determined or defined by) virtual material thickness 170 of thermoplastic composite structure model 158. Measuring material thickness 114 may be performed continuously or regularly, for example, at predetermined time intervals or at predetermined locations 134 on thermoplastic composite structure 102.

Referring to FIG. 16, and with reference to FIG. 1, in one example implementation, method 500 also includes the step of controlling material thickness 114 of fiber-reinforced thermoplastic material 106 throughout in situ placement of fiber-reinforced thermoplastic material 106 around mandrel 104 (block 502), as shown at block 532.

As one example, controlling material thickness 114 of fiber-reinforced thermoplastic material 106 (block 532) includes placing (block 502) and consolidating (block 504), in situ, additional fiber-reinforced thermoplastic material 106 at predetermined location 134.

Referring to FIG. 16, and with reference to FIG. 1, in one example implementation, method 500 also includes the step of monitoring structure shape 112 of thermoplastic composite structure 102 throughout in situ placement of fiber-reinforced thermoplastic material 106 around mandrel 104 (block 502), as shown at block 534.

As one example, monitoring structure shape 112 of thermoplastic composite structure 102 (block 534) includes measuring material thickness 114, for example, at predetermined location 134, as shown at block 536, and comparing a measured material thickness 114 to nominal material thickness 208 (FIG. 7), for example, at predetermined location 134, as shown at block 538. As one example, nominal material thickness 208 may correspond to (e.g., be determined or defined by) virtual material thickness 170 forming virtual structure shape 172 of thermoplastic composite structure model 158. Measuring material thickness 114 may be performed continuously or regularly, for example, at predetermined time intervals or at predetermined locations 134 on thermoplastic composite structure 102.

Referring to FIG. 16, and with reference to FIG. 1, in one example implementation, method 500 also includes the step of controlling structure shape 112 of thermoplastic composite structure 102 throughout in situ placement of fiber-reinforced thermoplastic material 106 around mandrel 104 (block 502), as shown at block 540.

As one example, controlling structure shape 112 of thermoplastic composite structure 102 (block 540) includes placing (block 502) and consolidating (block 504), in situ, additional fiber-reinforced thermoplastic material 106 at predetermined location 134.

Referring to FIG. 17, one example of method, generally designated 600, for making a thermoplastic composite structure (e.g., thermoplastic composite structure 102) (FIG. 1), is disclosed. Modifications, additions, or omissions may be made to method 600 without departing from the scope of the present disclosure. Method 600 may include more, fewer, or other steps. Additionally, steps may be performed in any suitable order.

In one example implementation, method 600 may include the step of providing mandrel 104 (not explicitly illustrated). The step of providing mandrel 104 may be the same as the step of providing mandrel 104 (block 508) in accordance with method 500 (FIG. 16). Method 600 may also include the step of coupling mandrel 104 to tooling fixture 176, in accordance with method 500.

Referring to FIG. 17, and with reference to FIGS. 1-11, in one example implementation, method 600 includes the step of heating initial ones of tows 122 of fiber-reinforced thermoplastic material 106, as shown at block 602. Tows 122 include bundles of reinforcing fibers 124 impregnated with thermoplastic resin 126. Method 600 also includes placing, in situ, the initial ones of tows 122 onto mandrel 104 to form an initial one of layers 128 of fiber-reinforced thermoplastic material 106 around mandrel 104, as shown at block 604. Mandrel 104 includes (e.g., is made from) soluble material 110. Method 600 also includes the step of heating subsequent ones of tows 122, as shown at block 606. Method 600 also includes the step of placing, in situ, the subsequent ones of tows 122 onto the initial ones of tows 122 and preceding ones of tows 122 to successively form subsequent ones of layers 128 of fiber-reinforced thermoplastic material 106 around mandrel 104, as shown at block 608. Method 600 also includes the step of applying consolidation force 220 (FIG. 7) to the subsequent ones of tows 122 to diffuse thermoplastic resin 126 between the initial ones of tows 122 and the subsequent ones of tows 122 and consolidate the initial one of layers 128 and the subsequent ones of layers 128, as shown at block 610. Method 600 also includes the step of cooling the initial ones of tows 122 and the subsequent ones of tows 122 to cohesively bond the initial one of layer 128 and the subsequent ones of layers 128 and form thermoplastic composite structure 102, as shown at block 612. Thermoplastic composite structure 102 includes material thickness 114 of fiber-reinforced thermoplastic material 106, structure shape 112, and hollow interior 116. Method 600 also includes the step of solubilizing mandrel 104 to remove mandrel 104 from within thermoplastic composite structure 102, as shown at block 614.

As one example, cooling the initial ones and the subsequent ones of tows 122 may be performed at ambient temperature. As one example, cooling the initial ones and the subsequent ones of tows 122 is performed between approximately 68 degrees and approximately 79 degrees Fahrenheit (e.g., at generally room temperature).

Referring to FIGS. 1 and 4-7, in one example implementation, the steps of heating (blocks 602 and 606) and placing, in situ, (blocks 604 and 608) the initial ones and the subsequent ones of tows 122 is performed using automated fiber placement (“AFP”) machine 196 (e.g., via an automated fiber placement process).

Referring to FIGS. 4-6, and with reference to FIG. 1, as one example, AFP machine 196 places, in situ, tows 122 onto mandrel 104. AFP machine 196 is configured to place or wrap tows 122 one at a time. As one example, and as illustrated in FIG. 4, the initial ones of tows 122a may be placed onto mandrel 104 by AFP machine 196 to form the initial one of layers 128a. The initial ones of tows 122a may be placed or oriented by AFP machine 196 at approximately a ninety-degree angle relative to the longitudinal axis A of thermoplastic composite structure 102 (e.g., in streamwise direction 138) (FIG. 2). As illustrated in FIG. 5, first subsequent ones of tows 122b may be placed onto the initial ones of tows 122a forming the initial one of layers 128a to form a first subsequent one of layers 128b. The first subsequent ones of tows 122b may be placed or oriented by AFP machine 196 at approximately a zero-degree angle relative to the longitudinal axis A of thermoplastic composite structure 102 (e.g., in lengthwise direction 136) (FIG. 2). As illustrated in FIG. 6, second subsequent ones of tows 122c may be placed onto the first subsequent ones of tows 122b forming the first subsequent one of layers 128b to form a second subsequent one of layers 128c. The second subsequent ones of tows 122c may be placed or oriented by AFP machine 196 at approximately a forty-five-degree angle relative to the longitudinal axis A of thermoplastic composite structure 102. While not explicitly illustrated, additional subsequent ones of tows 122 may be placed onto preceding ones of tows 122 to form additional subsequent ones of layers 128 to achieve the desired material thickness 114 and/or structure shape 112 of thermoplastic composite structure 102.

As one example, AFP machine 196 is movable relative to a fixed mandrel 104 during in situ placement and consolidation of tows 122 to form successive layers 128. AFP machine 196 may move linearly (e.g., along the X-axis, the Y-axis, and/or the Z-axis) and/or may rotate around (e.g., relative to) mandrel 104. As one example, AFP machine 196 moves in travel direction 212 (FIG. 7) during in situ placement and consolidation of fiber-reinforced thermoplastic material 106 (e.g., tows 122) to form layers 128.

As one example, mandrel 104 is movable relative to a fixed AFP machine 196 during in situ placement and consolidation of tows 122 to form successive layers 128. As described above, mandrel 104 may be couple to tooling fixture 176. Tooling fixture 176 may move mandrel linearly or rotationally relative to AFP machine 196.

Referring to FIG. 7, and with reference to FIGS. 1 and 4-6, as one example, tows 122 are placed over mandrel 104 to form successive layers 128 and form a desired material thickness 114 and structure shape 112 of thermoplastic composite structure 102. As illustrated in FIG. 7, the initial ones of tows 122a and the first subsequent ones of tows 122b have been previously placed by AFP machine 196 to form the initial one of layers 128a and the first subsequent one of layers 128b around mandrel 104. One of the second subsequent ones of tows 122c is currently being placed and consolidated, in situ, to form the second subsequent one of layers 128c.

As one example, AFP machine 196 includes heating device 198. Heating device 198 applies heat to the currently placed second subsequent one of tows 122c as it is dispensed from AFP machine, for example, from a tow feed (not explicitly illustrated), and also applies heat to previously placed first subsequent one of tows 122b. An area where heat is applied may be referred to as a heat affected zone 210. Heating device 198 raises both the currently placed second subsequent one of tows 122c and the previously placed first subsequent one of tows 122b within heat affected zone 210 to a suitable temperature to affect a cohesive thermoplastic bond between the second subsequent one of layers 128c and the first subsequent one of layers 128b.

Heating device 198 may include any suitable device capable of heating tows 122 within heat affected zone 210 to the desired melt bonding temperature. As examples, heating device 198 may include a laser, a hot gas torch, an ultrasonic heating device, an induction heating device, an infrared (“IR”) heating device, and the like.

As one example, AFP machine 196 also includes a consolidation device 200. Consolidation device 200 applies consolidation force 220 to press the currently placed second subsequent one of tows 122c against the previously placed first subsequent one of tows 122b and causing the bond between the second subsequent one of layers 128c and the first subsequent one of layers 128b.

Consolidation device 200 may be any suitable device or mechanism capable of applying a consolidation force and pressing adjacent ones of tows 122 together, for example, within heat affected zone 210. As examples, consolidation device 200 may include a compaction or compression roller, a tensioning device, and the like.

As one example, AFP machine 196 also includes cutting device 202. Cutting device 202 cuts each one of tows 122 following completion of a course of in situ placement and consolidation.

Referring to FIG. 17, and with reference to FIGS. 1 and 7, in one example implementation, method 600 also includes the step of monitoring at least one of material thickness 114 of fiber-reinforced thermoplastic material 106 and structure shape 112 of thermoplastic composite structure 102 throughout in situ placement and consolidation of tows 122, as shown at block 616.

In one example implementation, monitoring at least one of material thickness 114 of fiber-reinforced thermoplastic material 106 and structure shape 112 of thermoplastic composite structure 102 (block 616) includes the step of measuring material thickness 114, as shown at block 618. Material thickness 114 may be measured predetermined location 134. Monitoring at least one of material thickness 114 of fiber-reinforced thermoplastic material 106 and structure shape 112 of thermoplastic composite structure 102 also includes the step of determining nominal material thickness 208, as shown at block 620. Nominal material thickness 208 may be determined at predetermined location 134. Monitoring at least one of material thickness 114 of fiber-reinforced thermoplastic material 106 and structure shape 112 of thermoplastic composite structure 102 also includes the step of comparing a measured material thickness 114 to nominal material thickness 208, as shown at block 622.

Referring to FIG. 7, and with reference to FIG. 1, as one example, AFP machine 196 includes measuring device 204. Measuring device 204 may be configured to measure material thickness 114 of fiber-reinforced thermoplastic material 106 at predetermined location 134 and determine nominal material thickness 208.

Referring to FIG. 17, and with reference to FIGS. 1 and 7, in one example implementation, measuring material thickness (block 618) includes measuring linear dimension 214 between measuring device 204 (e.g., a known position of measuring device 204) and a position of an outermost subsequent one of layers 128, as shown at block 624.

Referring to FIG. 7, as one example, linear dimension 218 between inner mold line 118 (or surface of mandrel 104) and the position of measuring device 204 at predetermined location 134 is known. During or following in situ placement (block 610) and application of consolidation force 220 (block 612) (FIG. 16), measuring device 204 measures linear dimension 214 between the position of the second subsequent one of layers 128c (e.g., the position of an exterior surface thereof). Material thickness 114 is determined by the difference between known linear dimension 218 and measured linear dimension 214.

As one example, AFP machine 196 and/or measuring device 204 are communicatively coupled to and controlled by a computer (e.g., computer 156) (FIG. 1). Determining nominal material thickness 208 at predetermined location 134 may include extracting virtual material thickness 170 at predetermined location 134 from thermoplastic composite structure model 158. Nominal material thickness 208 corresponds to virtual material thickness 170 of thermoplastic composite structure model 158 at predetermined location 134, and, thus, is known.

Referring to FIG. 17, and with reference to FIGS. 1 and 7, in one example implementation, method 600 also includes the step of controlling at least one of material thickness 114 of fiber-reinforced thermoplastic material 106 and structure shape 112 of thermoplastic composite structure 102 throughout in situ placement and consolidation of tows 122, as shown at block 626.

As one example, controlling material thickness 114 of fiber-reinforced thermoplastic material 106 and/or structure shape 112 of thermoplastic composite structure 102 (block 626) includes heating (block 606), placing (block 608), and applying consolidation force 220 (block 610), in situ, additional subsequent ones of tows 122 at predetermined location 134.

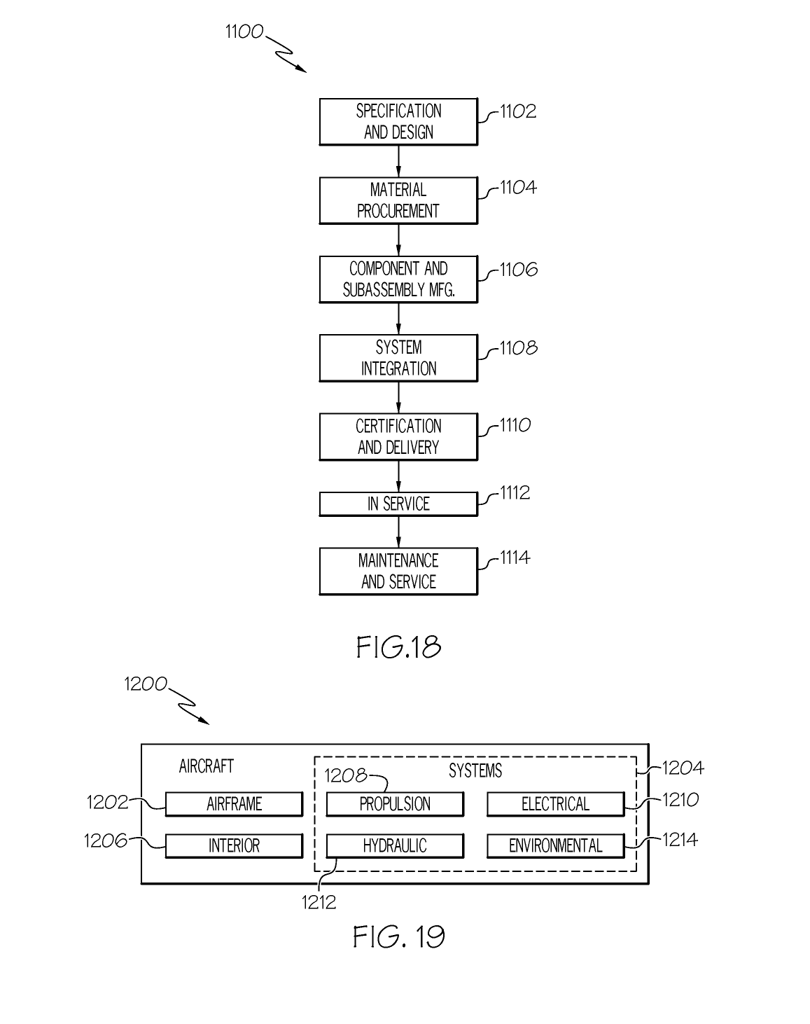

Examples of the present disclosure may be described in the context of aircraft manufacturing and service method 1100 as shown in FIG. 18 and aircraft 1200 as shown in FIG. 19.

During pre-production, the illustrative method 1100 may include specification and design, as shown at block 1102, of aircraft 1200 and material procurement, as shown at block 1104. During production, component and subassembly manufacturing, as shown at block 1106, and system integration, as shown at block 1108, of aircraft 1200 may take place. Thereafter, aircraft 1200 may go through certification and delivery, as shown block 1110, to be placed in service, as shown at block 1112. While in service, aircraft 1200 may be scheduled for routine maintenance and service, as shown at block 1114. Routine maintenance and service may include modification, reconfiguration, refurbishment, etc. of one or more systems of aircraft 1200.

Each of the processes of illustrative method 1100 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 19, aircraft 1200 produced by illustrative method 1100 may include airframe 1202 with a plurality of high-level systems 1204 and interior 1206. Examples of high-level systems 1204 include one or more of propulsion system 1208, electrical system 1210, hydraulic system 1212 and environmental system 1214. Any number of other systems may be included. Although an aerospace example is shown, the principles disclosed herein may be applied to other industries, such as the automotive industry, the marine industry, the construction industry or the like.

The apparatus and methods shown or described herein may be employed during any one or more of the stages of the manufacturing and service method 1100. For example, components or subassemblies corresponding to component and subassembly manufacturing (block 1106) may be fabricated or manufactured in a manner similar to components or subassemblies produced while aircraft 1200 is in service (block 1112). Also, one or more examples of the apparatus, systems and methods, or combination thereof may be utilized during production stages (blocks 1108 and 1110). Similarly, one or more examples of the apparatus and methods, or a combination thereof, may be utilized, for example and without limitation, while aircraft 1200 is in service (block 1112) and during maintenance and service stage (block 1114).

Although various embodiments of the disclosed apparatus and methods have been shown and described, modifications may occur to those skilled in the art upon reading the specification. The present application includes such modifications and is limited only by the scope of the claims.

What is claimed is:

1. A thermoplastic composite structure comprising:
a structure shape comprising an inner mold line and an outer mold line formed by in situ placement and consolidation of fiber-reinforced thermoplastic material around a mandrel;
a material thickness of said fiber-reinforced thermoplastic material formed between said inner mold line and said outer mold line of said thermoplastic composite structure; and
a hollow interior bound by said inner mold line,
wherein said mandrel is removed from within said hollow interior of said thermoplastic composite structure following in situ placement and consolidation of said fiber-reinforced thermoplastic material.

2. The structure of claim 1 wherein said fiber-reinforced thermoplastic material comprises tows of reinforcing fibers impregnated with a thermoplastic resin, and wherein said tows form layers of said fiber-reinforced thermoplastic material.

3. The structure of claim 2 further comprising layers of said fiber-reinforced thermoplastic material formed from successive in situ placement of said tows, wherein ones of said tows forming an innermost one of said layers define said inner mold line, and wherein other ones of said tows forming an outermost one of said layers define said outer mold line.

4. The structure of claim 2 wherein said material thickness at a location on said thermoplastic composite structure is controlled by at least one of a number of said tows at said location and a tow thickness of each one of said tows at said location.

5. The structure of claim 2 wherein said structure shape at a location on said thermoplastic composite structure is controlled by an in situ placement position of at least one of said tows relative to another in situ placement position of at least another one of said tows.

6. The structure of claim 2 wherein:
at least one of said layers is formed by ones said tows placed at a first angle relative to a longitudinal axis of said thermoplastic composite structure,
at least another one of said layers is formed by other ones of said tows placed at a second angle relative to said longitudinal axis of said thermoplastic composite structure, wherein said second angle is different from said first angle, and
at least yet another one of said layers is formed by yet other ones of said tows placed at a third angle relative to said longitudinal axis of said thermoplastic composite structure, wherein said third angle is different from said first angle and said second angle.

7. The structure of claim 1 wherein said structure shape varies along a lengthwise direction of said thermoplastic composite structure.

8. The structure of claim 1 wherein said structure shape comprises:
a first portion comprising a first cross-sectional profile;
a second portion comprising a second cross-sectional profile; and
a transition portion extending between said first portion and said second portion, wherein said transition portion comprises transition cross-sectional profiles that are different from and transition between said first cross-sectional profile and said second cross-sectional profile.

9. The structure of claim 1 wherein said material thickness of said fiber-reinforced thermoplastic material varies along a lengthwise direction of said thermoplastic composite structure.

10. The structure of claim 1 wherein said material thickness of said fiber-reinforced thermoplastic material varies along a hoopwise direction of said thermoplastic composite structure.

11. The structure of claim 1 wherein said mandrel is removed from within said hollow interior of said thermoplastic composite structure by at least one of solubilizing said mandrel and melting said mandrel.

12. A method comprising:
placing, in situ, fiber-reinforced thermoplastic material around a mandrel, wherein said mandrel comprises a soluble material;
consolidating, in situ, said fiber-reinforced thermoplastic material to form a thermoplastic composite structure; and
at least partially solubilizing said mandrel from within said thermoplastic composite structure to remove said mandrel and provide said thermoplastic composite structure comprising a material thickness of said fiber-reinforced thermoplastic material, a structure shape, and a hollow interior.

13. The method of claim 12 further comprising:
generating a thermoplastic composite structure model comprising a virtual inner mold line, a virtual outer mold line and a virtual hollow interior bound by said virtual inner mold line, wherein said virtual hollow interior comprises a virtual interior shape;
generating a mandrel model comprising a virtual mandrel shape, wherein said virtual mandrel shape is defined by said virtual interior shape; and
making said mandrel from said soluble material, said mandrel comprising a mandrel shape corresponding to said virtual mandrel shape.

14. The method of claim 13 wherein making said mandrel comprises making sections of said mandrel, wherein each one of said sections comprises a first section half and a second section half, and wherein said first section half and said second section half of said each one of said sections are configured to be coupled around a tooling fixture to form said mandrel.

15. The method of claim 12 wherein consolidating, in situ, said fiber-reinforced thermoplastic material to form said thermoplastic composite structure comprises:
heating said fiber-reinforced thermoplastic material;
applying a consolidation force to said fiber-reinforced thermoplastic material during in situ placement of said fiber-reinforced thermoplastic material; and
cooling said fiber-reinforced thermoplastic material after said in situ placement of said fiber-reinforced thermoplastic material.

16. The method of claim 12 further comprising monitoring said material thickness of said fiber-reinforced thermoplastic material throughout in situ placement of said fiber-reinforced thermoplastic material around said mandrel.

17. The method of claim 16 wherein monitoring said material thickness of said fiber-reinforced thermoplastic material comprises:
measuring said material thickness of said fiber-reinforced thermoplastic material; and
comparing a measured material thickness to a nominal material thickness.

18. The method of claim 16 further comprising controlling said material thickness of said fiber-reinforced thermoplastic material throughout in situ placement of said fiber-reinforced thermoplastic material around said mandrel.

19. The method of claim 18 wherein controlling said material thickness of said fiber-reinforced thermoplastic material comprises placing and consolidating, in situ, additional fiber-reinforced thermoplastic material at a predetermined location.

20. The method of claim 12 further comprising monitoring said structure shape of said thermoplastic composite structure throughout in situ placement of said fiber-reinforced thermoplastic material around said mandrel.

21. The method of claim 20 wherein monitoring said structure shape of said thermoplastic composite structure comprises:
measuring said material thickness of said fiber-reinforced thermoplastic material at a predetermined location; and
comparing a measured material thickness to a nominal material thickness.

22. The method of claim 20 further comprising controlling said structure shape of said thermoplastic composite structure throughout in situ placement of said fiber-reinforced thermoplastic material around said mandrel.

23. The method of claim 22 wherein controlling said structure shape of said thermoplastic composite structure comprises placing and consolidating, in situ, additional fiber-reinforced thermoplastic material at a predetermined location.

24. The method of claim 12 further comprising at least partially melting said mandrel from within said thermoplastic composite structure to remove said mandrel and provide said thermoplastic composite structure.

25. A method comprising:
heating initial ones of tows of fiber-reinforced thermoplastic material, wherein said tows comprise bundles of reinforcing fibers impregnated with a thermoplastic resin;
placing, in situ, said initial ones of said tows onto a mandrel to form an initial one of layers of said fiber-reinforced thermoplastic material around said mandrel, wherein said mandrel comprises a soluble material;
heating subsequent ones of said tows;
placing, in situ, said subsequent ones of said tows onto said initial ones of said tows and preceding ones of said tows to successively form subsequent ones of layers of said fiber-reinforced thermoplastic material around said mandrel;
applying a consolidation force to said subsequent ones of said tows to diffuse said thermoplastic resin between said initial ones of said tows and said subsequent ones of said tows and consolidate said initial one of said layers and said subsequent ones of said layers;
cooling said initial ones of said tows and said subsequent ones of said tows to cohesively bond said initial one of said layers and said subsequent ones of said layers and form a thermoplastic composite structure, wherein said thermoplastic composite structure comprises a material thickness of said fiber-reinforced thermoplastic material, a structure shape, and a hollow interior; and
solubilizing said mandrel to remove said mandrel from within said thermoplastic composite structure.

26. The method of claim 25 wherein heating and placing, in situ, said initial ones and said subsequent ones of said tows is performed using an automated fiber placement machine.

27. The method of claim 26 wherein applying said consolidation force to said subsequent ones of said tows is performed using said automated fiber placement machine.

28. The method of claim 25 wherein cooling said initial ones and said subsequent ones of said tows is performed between approximately 68 degrees and approximately 79 degrees Fahrenheit.

29. The method of claim 25 wherein:
said initial one of said layers comprises an initial layer thickness and an initial layer shape corresponding to a mandrel shape,
each of said subsequent ones of said layers comprises a subsequent layer thickness and an subsequent layer shape corresponding to a preceding layer shape, and
an outermost subsequent one of said layers forms an outer mold line of said thermoplastic composite structure corresponding to said structure shape.

30. The method of claim 25 further comprising monitoring at least one of said material thickness of said fiber-reinforced thermoplastic material and said structure shape of said thermoplastic composite structure throughout in situ placement and consolidation of said tows.

31. The method of claim 30 wherein monitoring at least one of said material thickness of said fiber-reinforced thermoplastic material and said structure shape of said thermoplastic composite structure comprises:
measuring said material thickness at a predetermined location;
determining a nominal material thickness at said predetermined location; and
comparing a measured material thickness to said nominal material thickness.

32. The method of claim 31 wherein measuring said material thickness comprises measuring a linear dimension between a measuring device and a position of an outermost subsequent one of said layers.

33. The method of claim 31 further comprising controlling at least one of said material thickness of said fiber-reinforced thermoplastic material and said structure shape of said thermoplastic composite structure throughout in situ placement and consolidation of said tows.
